(19) United States
(12) Patent Application Publication
(10) Pub. No.: US 2021/0285350 A1
(43) Pub. Date: Sep. 16, 2021

(54) Aging of a Catalytic Converter

(71) Applicant: CPT Group GmbH, Hannover (DE)

(72) Inventors: Ralf Moos, Bayreuth (DE); Willibald Reitmeier, Hemau (DE); Markus Dietrich, Regensburg (DE); Denny Schädlich, Neustadt (DE); Markus Hein, Bruck (DE); Katharina Burger, Regensburg (DE); Gunter Hagen, Schwarzenbach a. Wald (DE)

(73) Assignee: CPT Group GmbH, Hannover (DE)

(21) Appl. No.: 16/338,730

(22) PCT Filed: Sep. 26, 2017
(86) PCT No.: PCT/EP2017/074411

§ 371 Date: Apr. 2, 2019

(30) Foreign Application Priority Data
Oct. 10, 2016 (DE) 10 2016 219 644.8

(51) Int. Cl. F01N 3/20

(52) U.S. Cl. CPC F01N 3/208; F01N 2610/1453; F01N 2610/02; F01N 2900/04

(57) ABSTRACT

Various embodiments include a catalyst measuring system for determining the aging of an SCR catalytic converter, the system comprising: a control device with a processor; an SCR catalytic converter for treating the exhaust gases of a vehicle; a high-frequency sensor for measuring a level of ammonia loading of the SCR catalytic converter; and an ammonia dosing system for injecting ammonia into an exhaust system of the vehicle. The control device instructs the ammonia dosing system to inject ammonia selectively into the exhaust system. The control device compares data measured by the high-frequency sensor with a predefined threshold value to determine the aging of the SCR catalytic converter.

### CROSS-REFERENCE TO RELATED APPLICATIONS

This application is a U.S. National Stage Application of International Application No. PCT/EP2017/074411 filed Sep. 26, 2017, which designates the United States of America, and claims priority to DE Application No. 10 2016 219 644.8 filed Oct. 10, 2016, the contents of which are hereby incorporated by reference in their entirety.

### TECHNICAL FIELD

The present disclosure relates to internal combustion engines. Various embodiments include systems and methods to detect and account for aging of catalytic converters treating the exhaust gases of an engine without requiring additional components.

### BACKGROUND

Passenger cars or trucks with internal combustion engines have become a permanent part of modern society. The automobile industry is engaged in the development of vehicles which are distinguished by low emissions of pollutants and at the same time can be manufactured in a cost-effective manner. In particular, the development work is centred on nitrogen oxide reduction technologies. Therefore, new methods for exhaust gas purification are being developed in order to reduce the concentration of nitrogen oxides (NOx) in exhaust gases. One method is to use an ammonia SCR system. This system is advantageous, in particular, for lowering the NOx emissions of both trucks and passenger cars. In some SCR systems, a urea solution is injected as a reducing agent into the exhaust system of the vehicle. This liquid reducing agent is vaporized in the exhaust system and is ultimately converted into gaseous ammonia (NH3). With the aid of this ammonia, the noxious nitrogen oxides (NOx) are converted into nitrogen (N2) and water (H2O) in the ammonia SCR catalytic converter. So that the ammonia SCR reaction can take place, ammonia must be firstly and adsorbed, that is to say stored, in the SCR catalytic converter. The conversion of NOx can depend to a great extent on the quantity of stored ammonia, in particular at low catalyst temperatures.

### SUMMARY

The teachings of the present disclosure describe systems and methods to decrease the NOx emissions of a vehicle. For example, some embodiments include a catalyst measuring system (100) for determining the aging of an SCR catalytic converter (110) for a vehicle, having: a control device (120) for controlling the catalyst measuring system (100) and for evaluating the measurement data, an SCR catalytic converter (110) for purifying the exhaust gases of a vehicle, a high-frequency measuring arrangement (130) for measuring the ammonia loading of the SCR catalytic converter (110), and an ammonia dosing system (140) for injecting ammonia into an exhaust system (220) of the vehicle, wherein the control device (120) is designed to instruct the ammonia dosing system to inject ammonia selectively into the exhaust system (220), or to selectively inject no ammonia into the exhaust system (220), and wherein the control device (120) is designed to evaluate the data measured by the high-frequency measuring arrangement (130) and to compare it with a predefined threshold value, in order to determine the state of aging of the SCR catalytic converter (110) therefrom.

In some embodiments, the ammonia dosing system (140) is designed to inject ammonia into the exhaust system (220) of the vehicle until the SCR catalytic converter (110) is saturated.

In some embodiments, the high-frequency measuring arrangement (130) is designed to measure the resonance frequency of the SCR catalytic converter (110).

In some embodiments, the predefined threshold value is the resonance frequency of the fully loaded SCR catalytic converter (110) in the new state.

In some embodiments, the predefined threshold value is the resonance frequency of the fully loaded SCR catalytic converter (110) of a preceding measurement, preferably the directly preceding measurement.

In some embodiments, the control device (120) is designed to determine the state of aging of the SCR catalytic converter (110) by comparing the measured resonance frequency and the predefined threshold value of the resonance frequency.

In some embodiments, the high-frequency measuring arrangement (130) is designed to measure the dielectric losses of the SCR catalytic converter (110).

In some embodiments, the predefined threshold value is the dielectric losses of the fully loaded SCR catalytic converter (110) in the new state.

In some embodiments, the predefined threshold value is the dielectric losses of the fully loaded SCR catalytic converter (110) of a preceding measurement, preferably the directly preceding measurement.

In some embodiments, the control device (120) is designed to determine the state of aging of the SCR catalytic converter (110) by comparing the measured dielectric losses and the threshold value of the dielectric losses.

As another example, some embodiments include a vehicle (500) having an SCR catalytic converter (110) and a catalyst measuring system (100) as described above, for determining the state of aging of an SCR catalytic converter (110).

As another example, some embodiments include a method for determining the state of aging of an SCR catalytic converter, having the following steps: determining (401) a threshold value; initialising (402) the measurement by operating the SCR catalytic converter at a constant operating point without ammonia injection, with the result that no or little ammonia is stored in the SCR catalytic converter; injecting (403) ammonia into the exhaust system of the vehicle until saturation of the SCR catalytic converter is brought about; measuring (404) the ammonia loading of the SCR catalytic converter during the injection of ammonia; comparing (405) the measured data with the predefined threshold value; and determining (406) the state of aging of the SCR catalytic converter taking into account the comparison of the measured data with the predefined threshold value.

As another example, some embodiments include a program element which, when executed on a control device (120) of a catalyst measuring system (100), induces the catalyst measuring system (100) to carry out the methods described herein.

As another example, some embodiments include a computer-readable medium on which a program element as described herein is stored.

### BRIEF DESCRIPTION OF THE DRAWINGS

Further features, advantages, and possible uses of the teachings herein emerge from the following description of the exemplary embodiments and figures. The figures are schematic and not true to scale. If the same reference signs are specified in the following description in various figures, they denote identical or similar elements.

FIG. 1 shows a schematic illustration of a catalyst measuring system incorporating teachings of the present disclosure;

FIG. 2 shows a schematic illustration of a motor with an exhaust system and the catalyst measuring system incorporating teachings of the present disclosure;

FIG. 3 shows a diagram in which the time profile of the ammonia injection and of the ammonia loading of the SCR catalytic converter is illustrated.

FIG. 4 shows a flowchart for a method for determining the aging of an SCR catalytic converter incorporating teachings of the present disclosure; and

FIG. 5 shows a vehicle having an installed catalyst measuring system incorporating teachings of the present disclosure.

### DETAILED DESCRIPTION

Some embodiments of the teachings herein include a catalyst measuring system for determining the aging of an SCR catalytic converter for a vehicle. The catalyst measuring system has the following components: a control device for controlling the catalyst measuring system and for evaluating the measurement data, an SCR catalytic converter for purifying the exhaust gases of a vehicle, a high-frequency measuring arrangement for measuring the ammonia loading of an SCR catalytic converter and an ammonia dosing system for injecting ammonia into the exhaust system of a vehicle.

The control device is designed to instruct the ammonia dosing system to inject ammonia selectively into the exhaust system, or to selectively inject no ammonia into the exhaust system. The control device evaluates the data measured by the high-frequency measuring arrangement and compares it with a predefined threshold value.

The catalyst measuring system may have an ammonia-free SCR catalytic converter at the start of the measuring process, or a catalytic converter which is at a defined, stable operating point. A defined, stable operating point can be present when there is a constant temperature, when there is a constant volume flow of exhaust gas and/or when there is a constant EGR rate (exhaust gas recirculation rate). The ammonia dosing of the ammonia dosing system can be switched off for this. The catalyst measuring system can be operated without the dosing of ammonia until the high-frequency measuring arrangement detects a constant value for the ammonia loading, and the SCR catalytic converter is then free of ammonia. The high-frequency measuring arrangement can input electromagnetic waves into the exhaust train via small coupling elements, e.g. antennas, and the reflections or the transmission of the emitted electromagnetic waves can be measured. The electromagnetic waves correlate with the state of loading of the SCR catalytic converter. The metallic catalytic converter housing constitutes an electrical cavity resonator.

One or two simple antennas, for example, coaxial pin couplers or loop couplers which are introduced into catalytic converter housing, can serve as sensors. The di/electric properties of the SCR catalytic converter are determined by its ceramic honeycomb body, incl. the coating and the storage material and can be measured by means of the high-frequency measuring arrangement.

In exhaust gas catalytic converters, the changing of the resonance behaviour, for example the resonance frequency which is obtained from the reflection coefficients, can be used as a signal feature. Alternatively, the transmission can be used as a signal feature but this requires two antennas.

If high-frequency electromagnetic waves are input into a cavity resonator by means of an antenna, a plurality of standing waves, referred to as modes, are formed in the latter. Each mode has a separate oscillation pattern at the respective resonance frequency. These pronounced resonance points change their frequency and attenuation as a function of the state of loading of the SCR catalytic converter. It can therefore be possible to measure the ammonia loading of the SCR catalytic converter using this high-frequency measuring arrangement.

For the detection of aging, ammonia can be selectively dosed thereto at a constant dosing rate, and over-dosing can be carried out until all the storage locations of the SCR catalytic converter are occupied and saturation of the SCR catalytic converter is brought about. Both measurement parameters of the high-frequency measuring arrangement, the resonance frequency and the dielectric losses show a direct correlation with the stored ammonia and also become saturated or the measurement parameters reach a stable plateau. Therefore, the maximum storage capacity of the catalytic converter can be determined by means of the high-frequency signals. If the catalytic converter has aged, the catalytic effect thereof and the storage capacity decrease. Conversely, this is therefore a measure of the NOx conversion rate. As a result of its reduced storage capacity, the SCR catalytic converter reaches a lower plateau, and in addition the aged SCR catalytic converter also reaches the plateau more quickly at an identical ammonia dosing rate. Both effects are also apparent in the two measurement parameters.

The level of the plateaus, which corresponds to the maximum storage quantity, of the two high-frequency signals when saturation occurs, or the time required until the plateaus are reached, are used as a measure for the determination of aging. Both the level of the plateaus and the time until the plateau is reached decrease with increasing aging or decreasing activity of the SCR catalytic converter, and this is usually even a linear behavior. The system can be designed to carry out detection of aging at specific, for example regular, intervals, and the state of aging of the catalytic converter can therefore be monitored. Alternatively, the gradient, that is to say the change in the resonance frequency or the dielectric losses, can be used for the determination of aging. It is not necessary to provide an extra NOx sensor for detecting aging for the catalyst measuring system; the determination of aging takes place exclusively by means of the high-frequency measuring system. The entire emptying and saturation can be determined independently by the catalyst measuring system at constant operating points. The high-frequency measuring arrangement can measure the maximum possible ammonia loading of the SCR catalytic converter.

Such high-frequency measuring systems are in principle also suitable for determining the oxygen loading of the three-way catalytic converters, lean NOx traps (LMT), diesel oxidation catalytic converters (DOC) or for the measurement of the soot loading of particle filters. Therefore, the system which is described above and below can also be applied in these catalytic converters/particle filters.

In some embodiments, the ammonia dosing system may comprise an injection nozzle for injecting ammonia into the exhaust system, a supply tank for the ammonia, a pump, a heating system for the supply tank and the lines.

In some embodiments, the ammonia dosing system injects ammonia into the exhaust system of the vehicle until the SCR catalytic converter is saturated. The SCR catalytic converter can be freed completely of ammonia at the start of the measurement of aging, and therefore no further ammonia is stored in the SCR catalytic converter. As soon as the SCR catalytic converter is freed of ammonia, the ammonia dosing system can selectively inject and overdose ammonia into the exhaust system, with the result that ammonia is deposited in the SCR catalytic converter. Alternatively, a small amount of residual loading of ammonia can be present at the start of the measurement. The ammonia dosing system can inject ammonia until the SCR catalytic converter is completely loaded with ammonia. In this case, the SCR catalytic converter is completely saturated. The level of the plateau can be measured and compared with the reference.

In some embodiments, the high-frequency measuring arrangement measures the resonance frequency of the SCR catalytic converter. The high-frequency measuring arrangement can measure the resonance frequency of the SCR catalytic converter in order to determine the ammonia loading of the SCR catalytic converter. The resonance frequency of the SCR catalytic converter changes as a function of the quantity of stored ammonia in the SCR catalytic converter. If ammonia cannot be absorbed anymore by the SCR catalytic converter, the resonance frequency remains constant. The profile of the ammonia loading, that is to say how quickly the plateau is reached, also constitutes an important factor.

In some embodiments, the predefined threshold value is the resonance frequency of the fully loaded SCR catalytic converter in the new state. The aging can be calculated by the catalyst measuring system by comparing the measured parameters with a predefined threshold value. It is possible to draw conclusions about the state of aging of the SCR catalytic converter as a function of the comparison. The resonance frequency of the fully loaded SCR catalytic converter in the new state can serve as a possible threshold value. The aging of the SCR catalytic converter can therefore be determined with respect to the new state, or aging can be specified as a percentage. The resonance frequency of the last valid measurement of the catalyst measuring system can be an alternative. The aging can therefore be tracked step-by-step.

In some embodiments, the control device is designed to determine the state of aging of the SCR catalytic converter by means of the comparison of the measured resonance frequency and the threshold value of the resonance frequency. In other words, the control device of the catalyst measuring system can compare the measured resonance frequency with the stored resonance frequency and draw conclusions about the state of aging of the SCR catalytic converter from this comparison. The older the SCR catalytic converter, the smaller the quantity of stored ammonia in the SCR catalytic converter and therefore the higher the resonance frequency of the SCR catalytic converter.

In some embodiments, the high-frequency measuring arrangement measures the dielectric losses of the SCR catalytic converter. The high-frequency measuring arrangement can also measure the dielectric losses of the SCR catalytic converter in order to determine the ammonia loading of the SCR catalytic converter. The dielectric losses of the SCR catalytic converter change as a function of the quantity of stored ammonia in the SCR catalytic converter. If ammonia cannot be absorbed any more by the SCR catalytic converter, the dielectric losses remain constant.

In some embodiments, the predefined threshold value is the dielectric losses of the fully loaded SCR catalytic converter in the new state. The aging can be calculated by the catalyst measuring system by comparing the measured data with a predefined threshold value. It is possible to draw conclusions about the state of aging of the SCR catalytic converter as a function of the comparison. The dielectric losses of the fully loaded SCR catalytic converter in the new state can serve as a possible threshold value. The aging of the SCR catalytic converter can therefore be determined with respect to the new state, or aging can be specified as a percentage. The dielectric losses of the last valid measurement of the catalyst measuring system can be an alternative. The aging can therefore be tracked step-by-step.

In some embodiments, the control device determines the state of aging of the SCR catalytic converter by means of the comparison of the measured dielectric losses and the threshold value of the dielectric losses. In other words, the control device of the catalyst measuring system can compare the measured dielectric losses with the stored dielectric losses and draw conclusions about the state of aging of the SCR catalytic converter from this comparison.

In some embodiments, there is a vehicle having an SCR catalytic converter and a catalyst measuring system for determining the aging of an SCR catalytic converter. A vehicle can be equipped with the catalyst measuring system in order to decrease the NOx emissions of the vehicle. The catalyst measuring system is installed so that a satisfactory method of functioning of the SCR catalytic converter can be ensured. The catalyst measuring system can determine the state of aging of the SCR catalytic converter and measure the stored quantity of ammonia in the SCR catalytic converter. If certain limiting values are exceeded or undershot, the catalyst measuring system can report them or, if appropriate, adapt the control of the ammonia dosing system. The vehicle can be a gasoline vehicle, diesel vehicle, or biofuel or synthetic fuel or gas vehicle. The invention can also be used in hybrid vehicles with an internal combustion engine.

The vehicle is, for example, a motor vehicle, such as a car, a bus or a truck, or else also a rail vehicle, a ship, an aircraft such as a helicopter or an airplane.

In some embodiments, a method for determining the state of aging of an SCR catalytic converter, has the following steps:
determining a threshold value
initialising the measurement by operating the SCR catalytic converter at a constant operating point without ammonia injection, with the result that no or little ammonia is stored in the SCR catalytic converter
injecting ammonia into the exhaust system of the vehicle until saturation of the SCR catalytic converter is brought about
measuring the ammonia loading of the SCR catalytic converter during the injection of ammonia
comparing the measured data with the predefined threshold value
determining the state of aging of the SCR catalytic converter taking into account the comparison of the measured data with the predefined threshold value

In some embodiments, the reference parameters for a later comparison can be generated at the start of the method. Both the behaviour of an SCR catalytic converter in the new state or optionally the last valid measurement can be used for this. Subsequently, the actual measurement of the SCR catalytic converter can be started, and a constant operating point of the SCR catalytic converter can be adopted for this. At this constant operating point, the temperature, the volume flow and the EGR rate should be kept constant. Furthermore, in this phase ammonia is not injected into the exhaust system by the ammonia dosing system, with the result that the ammonia stored in the SCR catalytic converter reacts with the NOx from the exhaust gases. The SCR catalytic converter is therefore free of ammonia or alternatively still has a small residual quantity of ammonia.

The ammonia dosing system subsequently injects ammonia into the exhaust system until the SCR catalytic converter is completely loaded and cannot store any further ammonia. The injected quantity of ammonia must be, of course, greater than the consumption of the ammonia by the conversion of NOx into N2 and H2O in this case. The ammonia loading of the SCR catalytic converter is measured over the complete time period of the ammonia injection by means of the high-frequency measuring arrangement. The measured parameters can then be compared with the reference parameters. It is possible to draw conclusions about the state of aging of the SCR catalytic converter on the basis of the comparison. An SCR catalytic converter can absorb less ammonia as it increasingly ages, and in addition the SCR catalytic converter also reaches the absorbable quantity of ammonia more quickly. Therefore, it is possible to use both the absolute level of the measuring parameters and the time profile up to the point where saturation is reached for the comparison, and alternatively the gradient in a partial region of the rise. Therefore, the determination of the aging of the SCR catalytic converter can be carried out without additional sensors. However, this does not mean further sensors cannot be installed in the catalyst measuring system, in order, for example, to ensure further functions.

In some embodiments, the method permits the age of the SCR catalytic converter to be determined, in particular with respect to its ammonia storage capacity, which has a decisive effect on its conversion rate and thus on its method of functioning. The determination of aging is carried out without the inclusion of further sensors in the exhaust system and under defined operating conditions. Through knowledge of the maximum storage capacity, an ideal addition of ammonia and therefore an ideal storage quantity can be adjusted in the transient mode of the SCR catalytic converter, without a large amount of ammonia being unnecessarily used. As a result, high conversion rates are ensured and ammonia breakdowns are avoided. Therefore, the entire function of an SCR system can be basically improved, and operation can be carried out without ammonia slip. The consumption of ammonia is therefore reduced to the necessary minimum.

In some embodiments, the measured parameters and the reference parameters are the resonance frequency of the SCR catalytic converter. A measurement parameter which is detected by the high-frequency measuring arrangement can be the resonance frequency of the SCR catalytic converter. The resonance frequency is directly related to the ammonia loading of the SCR catalytic converter and therefore permits conclusions to be drawn about the state of loading. As soon as the resonance frequency no longer changes, despite further ammonia dosing, it can be assumed that the SCR catalytic converter is saturated. The measured dielectric losses are compared with the reference, and conclusions about the state of aging of the SCR catalytic converter can be drawn therefrom.

In some embodiments, there is a program element which, when executed by a control device of a catalyst measuring system, induces the catalyst measuring system to carry out the method described and/or a computer-readable medium, on which a computer program is stored, which, when executed by a control device of a catalyst measuring system, instructs the catalyst measuring system to carry out the method described.

FIG. 1 shows a schematic illustration of a catalyst measuring system 100. In order to ensure the best possible conversion of the NOx, it may be helpful to determine the stored quantity of ammonia in the SCR catalytic converter 110. The ammonia loading can be calculated using models which are based on signals from the widest variety of sensors and actuators of the exhaust system. Furthermore, engine operating status data can be input as an input variable into the models. Since the accuracy of the models is limited, and the parameters also change with time, an ammonia slip strategy can be applied. The problems arising here are, in particular, the inaccuracy of the model, since there is a fault chain of the individual components, e.g. in the engine controller, the temperature measurement, the sensor inaccuracies and the determination of the various actuator positions.

In order to counter the problems described above of indirect measurement and of the models, a direct measurement of the state of loading can be carried out using a high-frequency measuring arrangement 130 (HF measuring system), also referred to as a microwave method, in order to determine the ammonia loading of an SCR catalytic converter 110. In the embodiment shown, the high-frequency measuring arrangement 130 has two antennas for measurement, but an embodiment with one antenna is also possible.

In some embodiments, the catalyst measuring system 100 has an SCR catalytic converter 110, a control device 120, high-frequency measuring arrangement 130, and an ammonia dosing system 140. The SCR catalytic converter 110 serves to purify the exhaust gas of a vehicle of noxious NOx emissions. In order to purify the exhaust gas of NOx emissions, ammonia is additionally required and is injected in liquid form into the exhaust system of the vehicle by the ammonia dosing system 140. The injected ammonia vaporizes and converts the NOx into nitrogen and water in the SCR catalytic converter 110.

The control device 120 serves to control the injection of the ammonia by the ammonia dosing system 140, and in addition the control device 120 monitors the state of aging of the SCR catalytic converter 110. For the selective control and the determination of aging of the SCR catalytic converter, the control device 120 requires the current ammonia loading of the SCR catalytic converter 110, and this is ensured by the high-frequency measuring arrangement 130. The high-frequency measuring arrangement 130 is able to measure the resonance frequency and the dielectric losses of the SCR catalytic converter 110. Both measured parameters change as a function of the quantity of the stored ammonia in the SCR catalytic converter 110. The control device 120 can compare the measured parameters with the reference parameters. The reference parameters can relate to the new state of the SCR catalytic converter 110 or to the last valid measurement by the catalyst measuring system 100. Both the level of the plateau when the resonance frequency is saturated and the level of the dielectric losses or the time until the plateau is reached or the saturation is brought about can serve as comparison parameters. The state of aging of the SCR catalytic converter 110 can be obtained by means of the comparison. As aging progresses, the storage capacity of the SCR catalytic converter decreases.

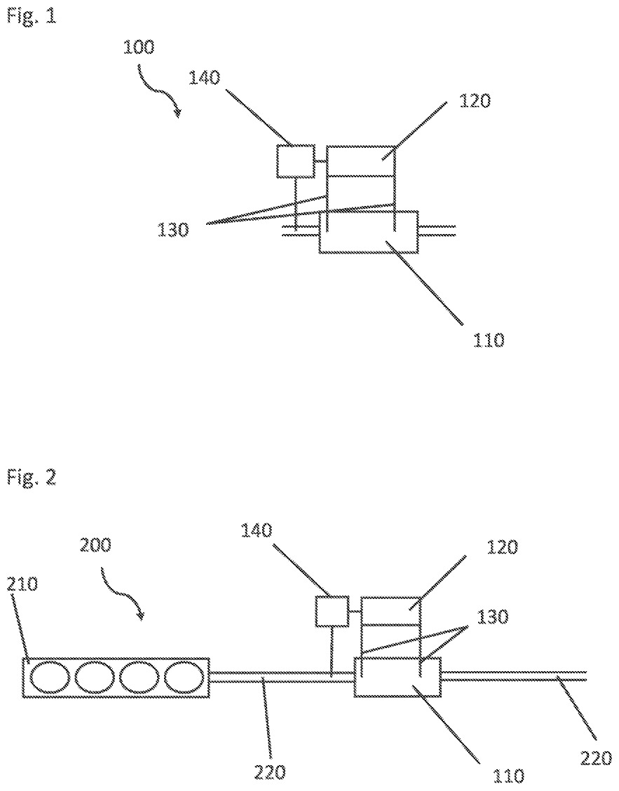

FIG. 2 shows the catalyst measuring system 100 from FIG. 1 installed in an exhaust system 220 of a vehicle. The internal combustion engine 210 generates energy and exhaust gases when fuel is burnt. Inter alia, nitrogen oxides (NOx) occur as a component of the exhaust gases. The exhaust gases are discharged into the environment by the exhaust system 220. So that not all the noxious exhaust gases can pass into the environment, exhaust gas purification systems, such as e.g. an SCR catalytic converter 110, are installed in the exhaust system 220. Furthermore, the catalyst measuring system 100 is installed in the exhaust system 220 in order to monitor the aging of the SCR catalytic converter 110 and to optimize the control of the SCR catalytic converter 110.

FIG. 3 shows a diagram in which the quantity of the injected ammonia, the stored quantity of ammonia in the SCR catalytic converter, the resonance frequency of the SCR catalytic converter and the dielectric losses of the SCR catalytic converter are plotted against the time. The continuous lines relate to an SCR catalytic converter in the new state, and the dashed lines relate to an aged SCR catalytic converter. The injected quantity of ammonia is the same in both cases. As result of the overdosing of ammonia, the ammonia which is not consumed is stored in the SCR catalytic converter until the latter is saturated. The saturation can be detected by means of the plateau. As soon as the SCR catalytic converter is in the saturated state, the SCR catalytic converter cannot absorb any further ammonia and the excess ammonia is discharged into the environment through the vehicle's exhaust pipe.

The plateau of the aged SCR catalytic converter is reached earlier and has a lower level than in the case of a new SCR catalytic converter. The resonance frequency and the dielectric losses behave in a way which corresponds to the quantity of stored ammonia in the SCR catalytic converter. As soon as saturation is brought about, the resonance frequency is constant. The ratio of the resonance frequencies and of the corresponding ammonia loading of the SCR catalytic converter permits conclusions to be drawn about the state of aging of the SCR catalytic converter. The behavior with the dielectric losses is the same as with the resonance frequency. Furthermore, it is apparent from the diagram that if the ammonia injection is stopped, the ammonia stored in the SCR catalytic converter is reduced and consumed.

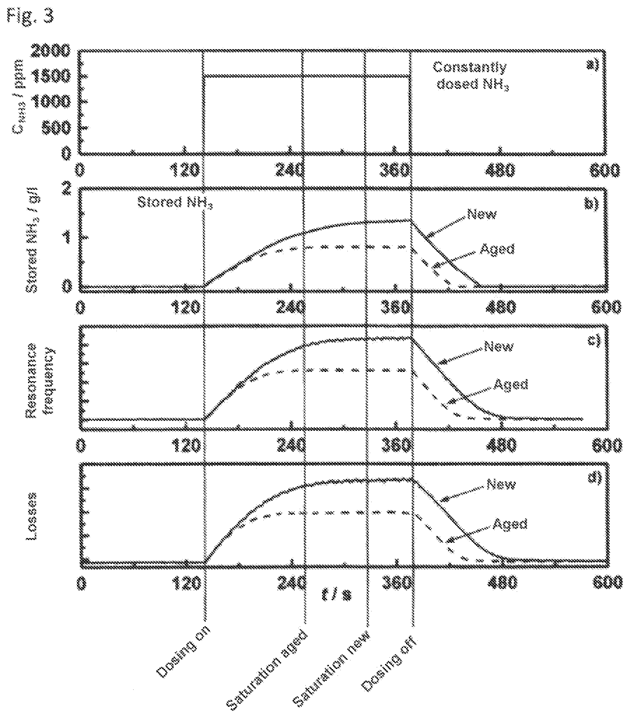

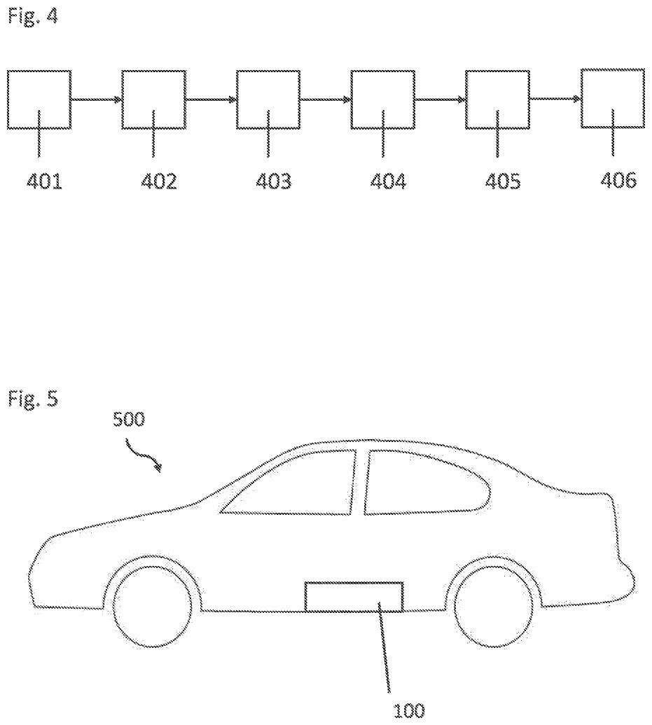

FIG. 4 shows a flow diagram for an example method for determining the state of aging of an SCR catalytic converter. In step 401, the reference parameters are determined for a later comparison. The initialization of the measurement is carried out in step 402. Here, the SCR catalytic converter is operated without ammonia injection at a constant operating point, or alternatively in the transient mode, with the result that no or little ammonia is stored in the SCR catalytic converter. Constant injection of ammonia until the saturation of the SCR catalytic converter is brought about takes place in step 403. In step 404, the ammonia loading of the SCR catalytic converter is measured during the constant ammonia injection. The comparison of the measured parameters and of the reference parameters takes place in step 405. Finally, in step 406, the state of aging of the SCR catalytic converter is determined from the comparison of the measured parameters.

FIG. 5 shows a vehicle 500 with an SCR catalytic converter 110 and a catalyst measuring system 100. The catalyst measuring system 100 can detect the state of aging of the SCR catalytic converter 110.

What is claimed is:

1. A catalyst measuring system for determining the aging of an SCR catalytic converter, the system comprising:
a control device with a processor;
an SCR catalytic converter for treating the exhaust gases of a vehicle;
a high-frequency sensor for measuring a level of ammonia loading of the SCR catalytic converter; and
an ammonia dosing system for injecting ammonia into an exhaust system of the vehicle;
wherein the control device instructs the ammonia dosing system to inject ammonia selectively into the exhaust system; and
the control device compares data measured by the high-frequency sensor with a predefined threshold value to determine the aging of the SCR catalytic converter.

2. The catalyst measuring system as claimed in claim 1, wherein the control device instructs the ammonia dosing system to inject ammonia into the exhaust system of the vehicle until the SCR catalytic converter is saturated.

3. The catalyst measuring system as claimed in claim 1, wherein the high-frequency sensor detects a resonance frequency of the SCR catalytic converter.

4. The catalyst measuring system as claimed in claim 1, wherein the predefined threshold value is a resonance frequency of the fully loaded SCR catalytic converter in a new state.

5. The catalyst measuring system as claimed in claim 1, wherein the predefined threshold value is a resonance frequency of the SCR catalytic converter when fully loaded as detected in a preceding measurement.

6. The catalyst measuring system as claimed in claim 1, wherein the control device determines the state of aging of the SCR catalytic converter by comparing a measured resonance frequency and a predefined threshold value of a resonance frequency.

7. The catalyst measuring system as claimed in claim 1, wherein the high-frequency sensor detects dielectric losses of the SCR catalytic converter.

8. The catalyst measuring system as claimed in claim 7, wherein the predefined threshold value corresponds to dielectric losses of the fully loaded SCR catalytic converter in a new state.

9. The catalyst measuring system as claimed in claim 7, wherein the predefined threshold value corresponds to dielectric losses of the SCR catalytic converter when fully loaded during a preceding measurement.

10. The catalyst measuring system as claimed in claim 7, wherein the control device determines the aging of the SCR catalytic converter by comparing measured dielectric losses and a threshold value of the dielectric losses.

11. A vehicle comprising:
an internal combustion engine;
an SCR catalytic converter in an exhaust tract of the internal combustion engine; and
a control device with a processor;
an SCR catalytic converter for treating the exhaust gases of a vehicle;
a high-frequency sensor for measuring a level of ammonia loading of the SCR catalytic converter; and
an ammonia dosing system for injecting ammonia into an exhaust system of the vehicle;
wherein the control device instructs the ammonia dosing system to inject ammonia selectively into the exhaust system; and
the control device compares data measured by the high-frequency sensor with a predefined threshold value to determine the aging of the SCR catalytic converter.

12. A method for determining the state of aging of an SCR catalytic converter in an exhaust system of an internal combustion engine, the method comprising:
initialising a measurement by operating the SCR catalytic converter at a constant operating point without ammonia injection, so no or little ammonia is stored in the SCR catalytic converter;
injecting ammonia into the exhaust system until the SCR catalytic converter is saturated;
measuring ammonia loading of the SCR catalytic converter during the injection of ammonia;
comparing the measured data with a predefined threshold value; and
determining the state of aging of the SCR catalytic converter based on the comparison of the measured data with the predefined threshold value.

13. (canceled)

14. A non-transitory computer-readable medium storing instructions for a processor to determine the state of aging of an SCR catalytic converter in an exhaust system of an internal combustion engine, the instructions, when loaded and executed by the processor, directing the processor to:
initialize a measurement by operating the SCR catalytic converter at a constant operating point without ammonia injection, so no or little ammonia is stored in the SCR catalytic converter;
inject ammonia into the exhaust system until the SCR catalytic converter is saturated;
measure ammonia loading of the SCR catalytic converter during the injection of ammonia;
compare the measured data with a predefined threshold value; and
determine the state of aging of the SCR catalytic converter based on the comparison of the measured data with the predefined threshold value.
